(19) United States
(12) Patent Application Publication
(10) Pub. No.: US 2007/0035889 A1
(43) Pub. Date: Feb. 15, 2007

(54) Spin valve magnetoresistive sensor in current perpendicular to plane scheme

(75) Inventors: Rachid Sbiaa, Tokyo (JP); Haruyuki Morita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: TDK CORPORATION, Tokyo (JP)

(21) Appl. No.: 10/572,069

(22) PCT Filed: Apr. 2, 2004
(86) PCT No.: PCT/JP04/04834

§ 371 Date: Mar. 15, 2006

(51) Int. Cl. G11B 5/127

(52) U.S. Cl. 360/324.1

(57) ABSTRACT

A magnetoresistive read head includes a spin valve having at least one free layer spaced apart from at least one pinned layer by a spacer. The pinned layer is highly resistive and includes a Co₁₀₀₋ₓFeₓ layer used in at least a part of the pinned layer. Optionally, this material may also be used in at least a part of the free layer. The value of x may be various values between 10 and 75 percent, plus or minus about 10 percent. The pinned layer is a single layer, or a synthetic multi-layered structure having a spacer between sub-layers. To increase resistivity, oxygen is introduced during deposition of either or both of the pinned layer and free layer.

### TECHNICAL FIELD

The present invention relates to the field of a read element of a magnetoresistive (MR) head. More specifically, the present invention relates to a spin valve of an MR read element with either or both of a free layer and a pinned layer having a high resistivity material.

### BACKGROUND ART

In the related art magnetic recording technology such as hard disk drives, a head is equipped with a reader and a writer. The reader and writer have separate functions and operate independently of one another, with no interaction therebetween.

FIGS. 1(a) and (b) illustrate related art magnetic recording schemes. A recording medium 1 having a plurality of bits 3 and a track width 5 has a magnetization 7 parallel to the plane of the recording media. As a result, a magnetic flux is generated at the boundaries between the bits 3. This is commonly referred to as “longitudinal magnetic recording” (LMR).

Information is written to the recording medium 1 by an inductive write element 9, and data is read from the recording medium 1 by a read element 11. A write current 17 is supplied to the inductive write element 9, and a read current is supplied to the read element 11.

The read element 11 is a sensor that operates by sensing the resistance change as the sensor magnetization direction changes from one direction to the other. A read current 15 is applied to the read sensor 11. A shield 13 reduces the undesirable magnetic fields coming from the media and prevents the undesired flux of adjacent bits from interfering with the one of the bits 3 that is currently being read by the read element 11.

In the foregoing related art scheme, the area density of the recording medium 1 has increased substantially over the past few years, and is expected to continue to increase substantially over the next few years. Correspondingly, the bit density and track density are expected to increase. As a result, the related art reader must be able to read this data having increased density at a higher efficiency and speed.

Due to these requirements, another related art magnetic recording scheme has been developed, as shown in FIG. 1(b). In this related art scheme, the direction of magnetization 19 of the recording medium 1 is perpendicular to the plane of the recording medium. This is also known as “perpendicular magnetic recording” (PMR). This design provides more compact and stable recorded data.

FIGS. 2(a)-(c) illustrate various related art read elements for the above-described magnetic recording scheme, known as “spin valves”. In the bottom type spin valve illustrated in FIG. 2(a), a free layer 21 operates as a sensor to read the recorded data from the recording medium 1. A spacer 23 is positioned between the free layer 21 and a pinned layer 25. On the other side of the pinned layer 25, there is an anti-ferromagnetic (AFM) layer 27.

In the top type spin valve illustrated in FIG. 2(b), the position of the layers is reversed. The operation of the related art spin valves illustrated in FIGS. 2(a)-(b) is substantially similar, and is described in greater detail below.

The direction of magnetization in the pinned layer 25 is fixed, whereas the direction of magnetization in the free layer 21 can be changed, for example (but not by way of limitation) depending on the effect of an external field, such as the recording medium 1.

When the external field (flux) is applied to a reader, the magnetization of the free layer 21 is altered, or rotated, by an angle. When the flux is positive the magnetization of the free layer is rotated upward, and when the flux is negative the magnetization of the free layer is rotated downward. Further, if the applied external field changes the free layer 21 magnetization direction to be aligned in the same way as pinned layer 25, then the resistance between the layers is low, and electrons can more easily migrate between those layers 21, 25.

However, when the free layer 21 has a magnetization direction opposite to that of the pinned layer 25, the resistance between the layers is high. This high resistance occurs because it is more difficult for electrons to migrate between the layers 21, 25. There is a related art need to have a high resistance, especially as spin valve size decreases.

Similar to the external field, the AFM layer 27 provides an exchange coupling and keeps the magnetization of pinned layer 25 fixed. The properties of the AFM layer 27 are due to the nature of the materials therein. In the related art, the AFM layer 27 is usually PtMn or IrMn.

The resistance change between when the layers 21, 25 are parallel and anti-parallel ΔR should be high to have a highly sensitive reader. As head size decreases, the sensitivity of the reader becomes increasingly important, especially when the magnitude of the media flux is decreased. Thus, there is a need for a high resistance change ΔR between the layers 21, 25 of the related art spin valve.

FIG. 2(c) illustrates a related art dual type spin valve. Layers 21 through 25 are substantially the same as described above with respect to FIGS. 2(a)-(b). However, an additional spacer 29 is provided on the other side of the free layer 21, upon which a second pinned layer 31 and a second AFM layer 33 are positioned. The dual type spin valve operates according to the same principle as described above with respect to FIGS. 2(a)-(b). However, an extra signal provided by the second pinned layer 31 increases the resistance change ΔR.

FIG. 6 graphically shows the foregoing principle in the case of the related art longitudinal magnetic recording scheme as illustrated in FIG. 1(a). As the magnetic recording media moves across the sensor, the flux of the recording media at the boundary between bits, as shielded with respect to adjacent bits, provides the flux to the free layer, which acts according to the related art spin valve principles.

The operation of the related art spin valve is now described in greater detail. In the recording media 1, flux is generated based on polarity of adjacent bits. If two adjoining bits have negative polarity at their boundary the flux will be negative. On the other hand, if both of the bits have positive polarity at the boundary the flux will be positive. The magnitude of flux determines the angle of magnetization between the free layer and the pinned layer.

In addition to the foregoing related art spin valve in which the pinned layer is a single layer, FIG. 3 illustrates a related art synthetic spin valve. The free layer 21, the spacer 23 and the AFM layer 27 are substantially the same as described above. In FIG. 3 only one state of the free layer is illustrated. However, the pinned layer further includes a first sublayer 35 separated from a second sublayer 37 by a spacer 39.

In the related art synthetic spin valve, the first sublayer 35 operates according to the above-described principle with respect to the pinned layer 25. Additionally, the second sublayer 37 has an opposite spin state with respect to the first sublayer 35. As a result, the pinned layer total moment is reduced due to anti-ferromagnetic coupling between the first sublayer 35 and the second sublayer 37. A synthetic spin valve head has a pinned layer with a total magnetic flux close to zero and thus greater stability and high pinning field can be achieved than with the sin gle layer pinned layer structure.

FIG. 4 illustrates the related art synthetic spin valve with a shielding structure. As noted above, it is important to avoid unintended magnetic flux from adjacent bits from being sensed during the reading of a given bit. A protective layer 41 is provided on an upper surface of the free layer 21 to protect the spin valve against oxidation before deposition of top shield 43, by electroplating in separated system. Similarly, a bottom shield 45 is provided on a lower surface of the AFM layer 27. A buffer layer, not shown in FIG. 4, is usually deposited before AFM layer 27 for a good spin-valve growth. The effect of the shield system is shown in FIG. 6, as discussed above.

As shown in FIGS. 5(a)-(d), there are four related art types of spin valves. The type of spin valve structurally varies based on the structure of the spacer 23.

The related art spin valve illustrated in FIG. 5(a) uses the spacer 23 as a conductor, and is used for the related art CIP scheme illustrated in FIG. 1(a) and (b) for a giant magnetoresistance (GMR) type spin valve. The direction of sensing current magnetization, as represented by “i”, is in the plane of the GMR element.

In the related art GMR spin valve, resistance is minimized when the magnetization directions (or spin states) of the free layer 21 and the pinned layer 25 are parallel and is maximized when the magnetization directions are opposite. As noted above, the free layer 21 has a magnetization of which the direction can be changed. Thus, the GMR system avoids perturbation of the head output signal by minimizing the undesired switching of the pinned layer magnetization.

GMR depends on the degree of spin polarization (represented as β) of the pinned and free layers, and the angle between their magnetic moments. Spin polarization of each layer depends on the difference between the number of electrons having spin states up and down.

Resistivity (represented as ρ) is a measure of the contribution of the nature of a material to resistance, which is represented as R=ρL/A, where R is the material resistance, L the length and A the cross sectional area. For the related art spin valve, this intrinsic resistivity can be divided by (1−β²) to obtain the Normalized resistivity ρ*. The normalized resistivity ρ* is proportional to ΔR, so that a large β corresponds to a larger ΔR. Because a larger ΔR is desirable in the related art, there is a need to have a related art material having properties that produce a high value of ρ.

In the related art spin valves, the free layer and the pinned layer are formed of CoFe, by deposition in an argon gas environment. Due to the nature of this material, the value of ρ that is produced does not generate a sufficiently large ΔR to produce spin valves of sufficient quality as the above-described size changes occur in spin valves, such as decreased size. For example, but not by way of limitation, due to the nature of CoFe as deposited in the spin valve, the pinned and/or free layer cannot be made sufficiently thin to reduce the overall thickness of the spin valve as needed to accommodate advances in the related art. Thus, there is an unmet need for a material that can provide improved resistivity.

The GMR scheme will now be discussed in greater detail. As the free layer 21 receives the flux that signifies bit transition, the free layer magnetization rotates by a small angle in one direction or the other, depending on the direction of flux. The change in resistance between the pinned layer 25 and the free layer 21 is proportional to angle between the moments of the free layer 21 and the pinned layer 25. There is a relationship between resistance change and efficiency of the reader.

The GMR spin valve has various requirements. For example, but not by way of limitation, a large resistance change ΔR is required to generate a high output signal. Further, low coercivity is desired, so that small media fields can also be detected. With high pinning field strength, the AFM structure is well defined. When the interlayer coupling is low the sensing layer is not adversely affected by the pinned layer. Further, low magnetistriction is desired to minimize stress on the free layer.

However, the foregoing related art CIP-GMR has various disadvantages. One of them is that the electrode connected to the free layer must be reduced in size that will cause overheating and damage to the head. Also, the re adout signal available from CIP-GMR is proportional to the MR head width. As a result, there is a limitation for CIP-GMR at high recording density.

As a result, related art magnetic recording schemes use a CPP-GMR head, where the sensing current flows perpendicular to the spin valve plane. As a result, size can be reduced and thermal stability can be increased. Various related art spin valves that operate in the CPP scheme are illustrated in FIGS. 5(b)-(d), and are discussed in greater detail below.

FIG. 5(b) illustrates a related art tunneling magnetoresistive (TMR) spin valve for CPP scheme. In the TMR spin valve, the spacer 23 acts as an insulator, or tunnel barrier layer. Thus, the electrons can cross the insulating spacer 23 from free layer to pinned layer or verse versa without losing their spin direction. TMR spin valves have an increased magnetic resistance (MR) on the order of about 30-50%.

FIG. 5(c) illustrates a related art CPP-GMR spin valve. While the general concept of GMR is similar to that described above with respect to CIP-GMR, the current is transferred perpendicular to the plane, instead of in-plane. As a result, the difference in resistance and the intrinsic MR are substantially higher than the CIP-GMR.

In the related art CPP-GMR spin valve, there is a need for a large resistance change ΔR, and a moderate element resistance for having a high frequency response. A low coercivity is also required so that a small media field can be detected. The pinning field should also have a high strength. Additional details of the CPP-GMR spin valve are discussed in greater detail below.

FIG. 5(d) illustrates the related art ballistic magnetoresistance (BMR) spin valve. In the spacer 23, which operates as an insulator, a ferromagnetic region 47 connects the pinned layer 25 to the free layer 21. The area of contact is on the order of a few nanometers. As a result, there is a substantially high MR, due to electrons scattering at the domain wall created within this nanocontact. Other factors include the spin polarization of the ferromagnets, and the structure of the domain that is in nano-contact with the BMR spin valve.

However, the related art BMR spin valve is in early development. Further, there are related art issues with the BMR spin valve in that nano-contact shape and size controllability and stability of the domain wall must be further developed. Additionally, the repeatability of the BMR technology is yet to be shown for high reliability.

In the foregoing related art spin valves of FIGS. 5(a)-(d), the spacer 23 of the spin valve is an insulator for TMR, a conductor for GMR, and an insulator having a magnetic nano-sized connector for BMR. While related art TMR spacers are generally made of more insulating metals such as alumina, related art GMR spacers are generally made of more conductive metals, such as copper.

FIGS. 7(a)-(b) illustrate the structural difference between the CIP and CPP GMR spin valves. As shown in FIG. 7(a), there is a hard bias 998 on the sides of the GMR spin valve, with an electrode 999 on upper surfaces of the GMR. Gaps 997 are also required. As shown in FIG. 7(b), in the CPP-GMR spin valve, an insulator 1000 is deposited at the side of the spin valve that the sensing current can only flow in the film thickness direction. Further, no gap is needed in the CPP-GMR spin valve.

As a result, the current has a much larger surface through which to flow, and the shield also serves as an electrode. Hence, the overheating issue is substantially addressed.

Further, the spin polarization of the layers of the spin valve is intrinsically related to the electronic structure of the material, and a highly resistive material can induce an increase in the resistance change.

Accordingly, there is an unmet need for a material, for use in the ferromagnetic layer, having the necessary properties and thickness for operation in a CPP-GMR system.

Additional factors associated with the performance of the related art CPP-GMR system are provided below. Various related art studies have demonstrated the effect of electron spin polarized on magnetization switching, including M. Tsoi et al., Phys. Review Letters, 80, 4281 (1998), J. C. Slonczewski, J. Magnetism and Magnetic Materials, 195, L261 (1999), J. A. Katine et al., Phys. Review Letters, 84, 3149 (2000),M. R. Pufall et al., Applied Physics Letters, 83 (2), 323 (2003), the contents of which are incorporated herein by reference.

In the related art studies, correlation between intrinsic properties and spin transfer switching has been determined. Also, dynamic response of magnetization switching has been studied. In conclusion, the ability of the head (sensor) to engage in fast switching of magnetization at a high frequency (e.g., GigaHertz) is important for high-speed reading of the recorded information (high data rate).

As recording media bit size is reduced, a thinner free layer is also needed. In the related art, there is currently a need for a free layer with a thickness of less than 3 nm for a sensor having a recording density of about 150 GB per square inch. In the future, it is believed that the need to reduce free layer thickness will continue. There is also a need to sense increasingly smaller bits at a very high frequency (i.e., high data rate) in recording head reader technology.

There are various problems and disadvantages in the related art. For example, but not by way of limitation, the related art problem of noise associated with a high magnetostriction is described above. As a result of the foregoing related art problems, the signal to noise ratio is reduced. As a result of the foregoing limitations of the pinned layer and/or free layer material, the related art spin valve cannot be made sufficiently small.

Accordingly, there is a related art need to minimize the related art problems caused by high magnetostriction, such that the free layer magnetic anisotropy will have a distribution and consequently the output signal symmetry will be reduced.

### DISCLOSURE OF INVENTION

It is an object of the present invention to overcome at least the aforementioned problems and disadvantages of the related art. However, it is not necessary for the present invention to overcome those problems and disadvantages, nor any problems and disadvantages.

To achieve at least this object and other objects, a magnetic sensor for reading a recording medium and having a spin valve is provided, comprising a free layer having an magnetization adjustable in response to an external field, a pinned layer having a fixed magnetization and including a high resistivity material in at least a portion of the pinned layer, the pinned layer having a resistivity between about 80 μΩcm and about 150 μΩcm, and a spacer sandwiched between the pinned layer and the free layer.

Additionally, a magnetic sensor for reading a recording medium and having a spin valve is provided, comprising a free layer having an magnetization adjustable in response to an external field and including a high resistivity material in at least a portion of the free layer, the free layer having a resistivity between about 20 μΩcm and about 200 μΩcm, a pinned layer having a fixed magnetization, and a spacer sandwiched between the pinned layer and the free layer.

Further, a magnetic sensor for reading a recording medium and having a spin valve is provided, comprising a free layer having an magnetization adjustable in response to an external field, a pinned layer having a fixed magnetization, and a spacer sandwiched between the pinned layer and the free layer. In this magnetic sensor, a high resistivity material is positioned in a portion of at least one of (a) the pinned layer having a resistivity greater than about 80 μΩcm, and (b) the free layer having a resistivity greater than about 20 μΩcm, and the high resistivity material is formed by performing deposition of the at least one of the pinned layer and the free layer in an argon gas environment having at least 2 percent oxygen gas.

### BRIEF DESCRIPTION OF DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIGS. 1(a) and (b) illustrates a related art magnetic recording scheme having in-plane and perpendicular-to-plane magnetization, respectively;

FIGS. 2(a)-(c) illustrate related art bottom, top and dual type spin valves;

FIG. 3 illustrates a related art synthetic spin valve;

FIG. 4 illustrates a related art synthetic spin valve having a shielding structure;

FIGS. 5(a)-(d) illustrates various related art magnetic reader spin valve systems;

FIG. 6 illustrates the operation of a related art GMR sensor system;

FIGS. 7(a)-(b) illustrate related art CIP and CPP GMR systems, respectively;

FIGS. 8(a)-(b) illustrate simulation results for use of an exemplary, non-limiting embodiment of the present invention that includes a novel pinned layer;

FIG. 9 illustrates simulation results for use of another exemplary, non-limiting embodiment of the present invention that includes a novel pinned layer and free layer;

FIG. 10 illustrates a comparison of performance for various resistivities of the present invention;

FIG. 11 illustrates spin-valve resistance as a function of thickness for simulation of various embodiments of the present invention;

FIG. 12(a)-(b) illustrate a structure for evaluating resistance of the spin valve according to an exemplary, non-limiting embodiment of the present invention;

FIG. 13 illustrates results of the change in magnetic properties for various exemplary, non-limiting embodiments of the present invention; and

FIG. 14 illustrates a structural depiction of an exemplary, non-limiting embodiment of the present invention.

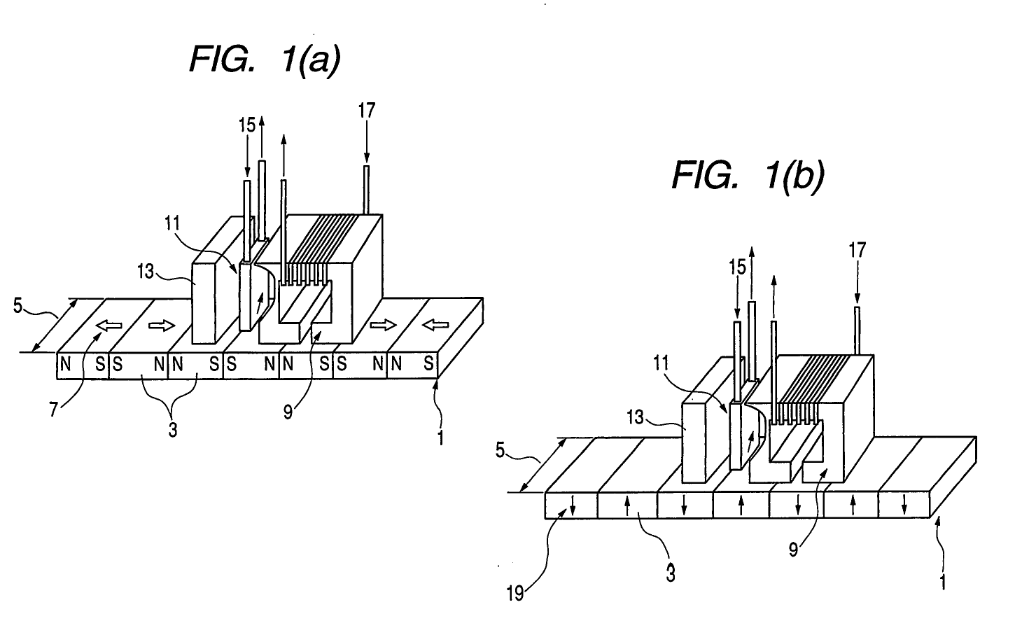

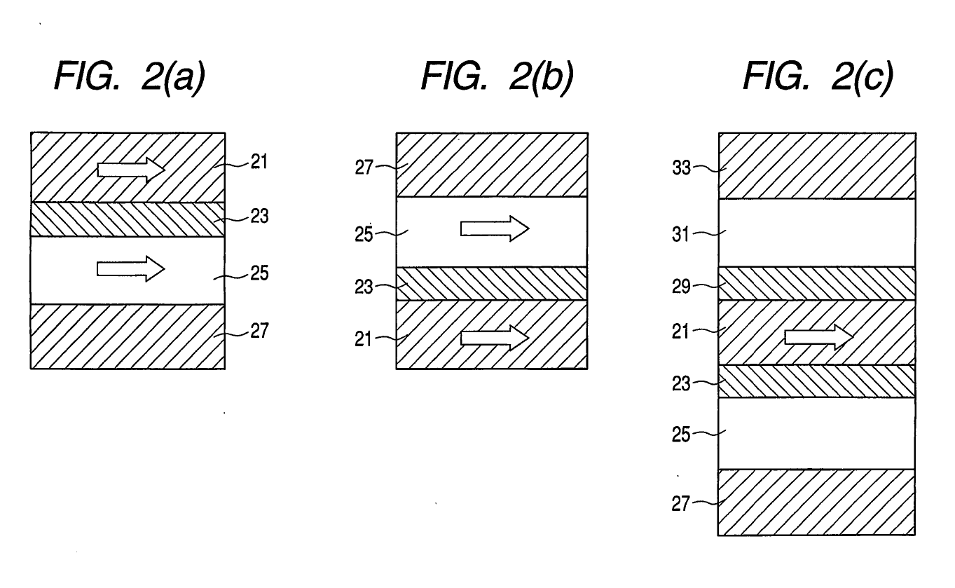

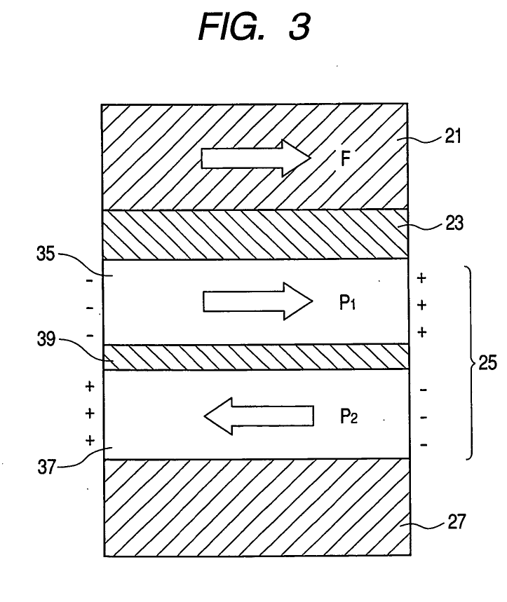

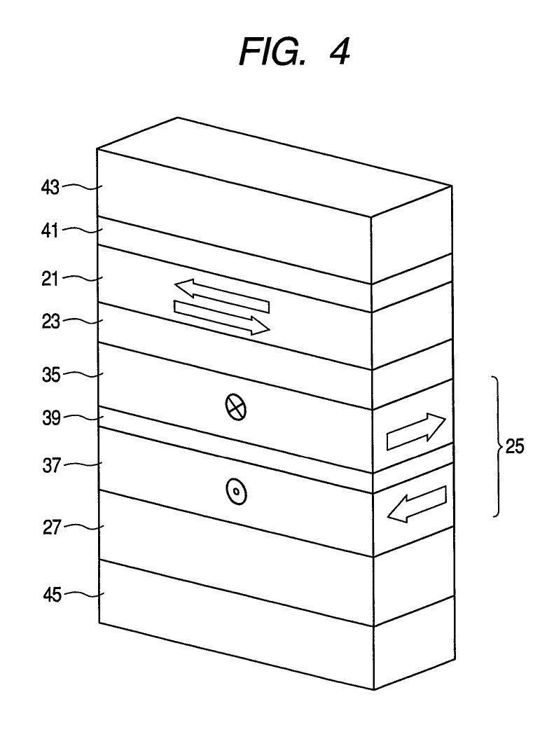

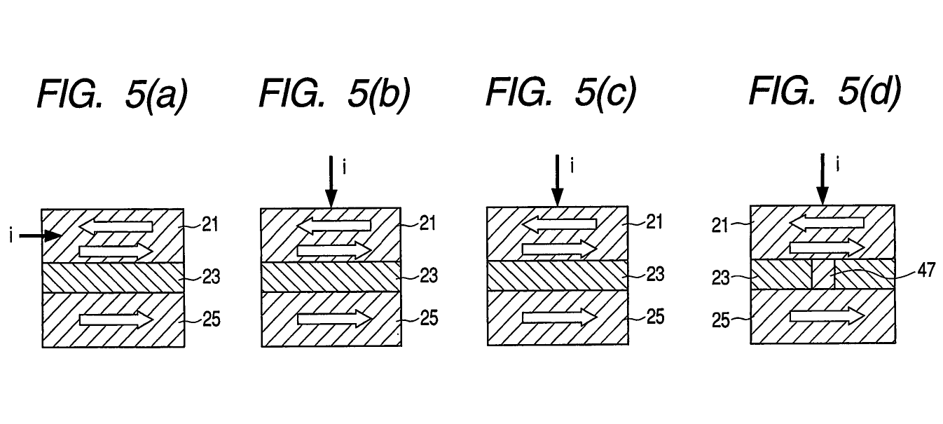

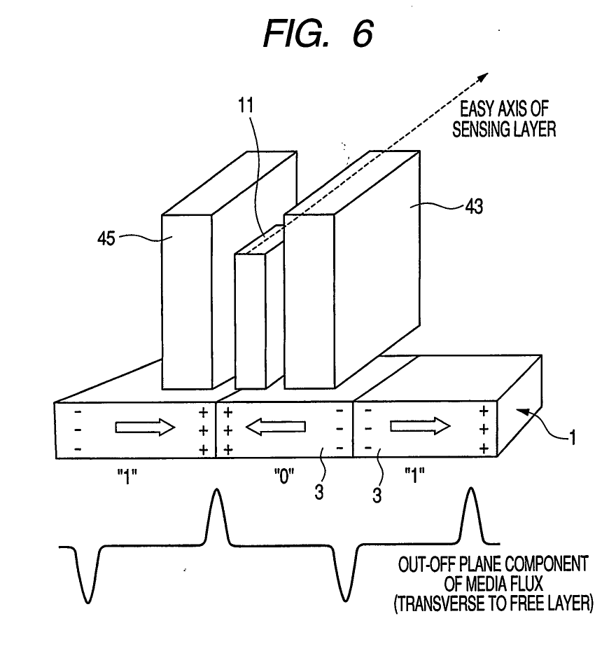

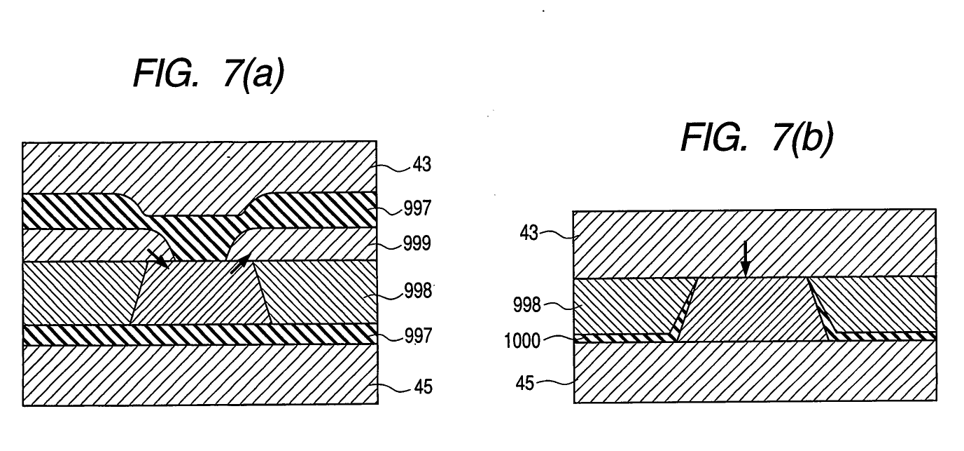

### MODES FOR CARRYING OUT THE INVENTION

Referring now to the accompanying drawings, description will be given of preferred embodiments of the invention. In an exemplary, non-limiting embodiment of the present invention, a novel spin valve for a magnetoresistive head having a ferromagnetic (FM) layer material with high resistivity is provided, resulting in an improved spin valve. This material may be used in either or both of the free layer and the pinned layer. The present invention is directed to applications that use a current perpendicular to plane (CPP) scheme.

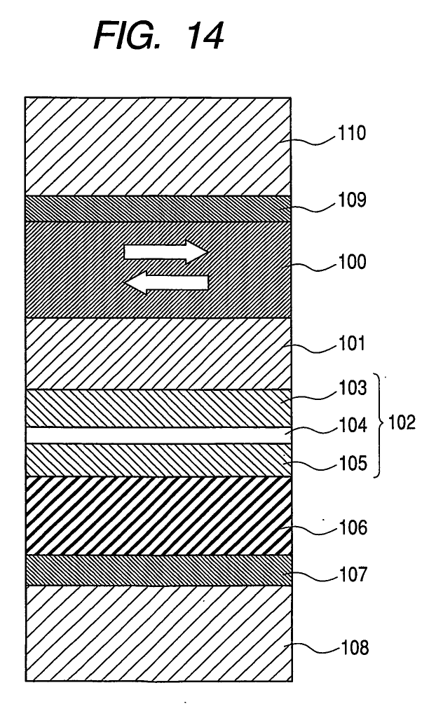

FIG. 14 illustrates the general structure of a bottom-type synthetic spin valve according to the present invention. However, as noted below, a top or dual type spin valve may be substituted therefor. Additionally, the pinned layer may be a single layer instead of a synthetic multi-layer structure.

In a first exemplary, non-limiting embodiment of the present invention, the pinned layer comprises the high resistivity material. A free layer 100 is positioned on a spacer 101, and the spacer 101 is sandwiched between the free layer 100 and a pinned layer structure 102. The spacer is made of Cu and is about 2.4 nm thick.

The pinned layer structure 102 is synthetic, and includes the pinned layer 103 next to the spacer 101, a pinned layer spacer 104, and a ferromagnetic secondary pinned layer 105. In this detailed description, the term “pinned layer” is understood to refer to the pinned layer 103 unless otherwise indicated.

Additionally, an antiferromagnetic (AFM) layer 106 is positioned on the secondary pinned layer 105. A capping layer 109 and a buffer layer 107 are positioned outside the free layer 100 and AFM layer 106, respectively, are made of NiCr and each have a thickness of about 5 nm. The AFM layer 106 is PtMn, IrMn or the like and has a thickness of about 7 nm. The secondary pinned layer 105 is made of CoFe and has a thickness of about 2.5 nm, while the pinned layer spacer 104 has a thickness of about 0.8 nm and is made of Ru.

In the first exemplary, non-limiting embodiment of the present invention, the free layer 100 is made of CoFe and has a thickness of about 3 nm. The pinned layer 103 is made of a high resistance material, and has a thickness of about 3 nm. This high resistance material includes Co₁₀₀₋ₓFeₓ, where x represents an approximate relative concentration of Fe with respect to Co. More specifically, values of x may be 10, 16, 25, 35, 50, 56 or 75, plus or minus about 10 percent.

The foregoing pinned layer material has an increased resistivity due to in-situ oxygen gas present in a concentration of about 2 percent during deposition of the high resistivity material. The resistivity of the formed pinned layer 103 is about 80-150 μΩcm, preferably having a value of about 90 or 100 μΩ·cm.

This structure may be formed as a monolayer within the pinned layer 103 or combined with other sublayers. Further, this high resistivity material is used in at least a portion of the pinned layer 103, but may be used in the entire pinned layer 103 as well.

In a second exemplary, non-limiting embodiment of the present invention, the foregoing material as described with respect to the pinned layer 103 is instead used in only the free layer 100. In this embodiment, the pinned layer 103 is made of CoFe as in the related art, and all layer thicknesses are maintained as previously discussed. The pinned layer 103 with CoFe has similar issues to the free layer 100 in terms of resistivity, as discussed above with respect to the related art.

Accordingly, in a third exemplary, non-limiting embodiment of the present invention, the pinned layer 103 and the free layer 100 are both made of the high resistivity material.

In the foregoing embodiments, the value of X can vary between the pinned layer 103 and the free layer 100. Further, the free layer 100 and the pinned layer 103 need not have the same value of X, or have the material deposited in the film of the respective layer in the same manner or location.

In the foregoing embodiments, increasing the resistance of the pinned layer 103, and optionally also the free layer 100 has a strong effect on the performance of the spin valve in the CPP scheme.

In comparison, the related art deposition method of formation uses pure argon gas, and does not use any oxygen therein. The use of the oxygen gas in the amount of about 2 percent during deposition of the ferromagnetic layer (free, pinned or both, depending on the embodiment) results in increased resistivity where such a process is used in the formation of the free and/or pinned layer(s) 100, 103.

While the foregoing in-situ scheme for the high resistivity material is discussed with respect to the present invention, this invention is not limited thereto, and other methods as known by those skilled in the art may be employed. For example, but not by way of limitation, other in-situ oxidation methods, as well as ex-situ oxidation and ferromagnetic layer alloys including (but not limited to) metals such as Cu, Mn and Cr may be used.

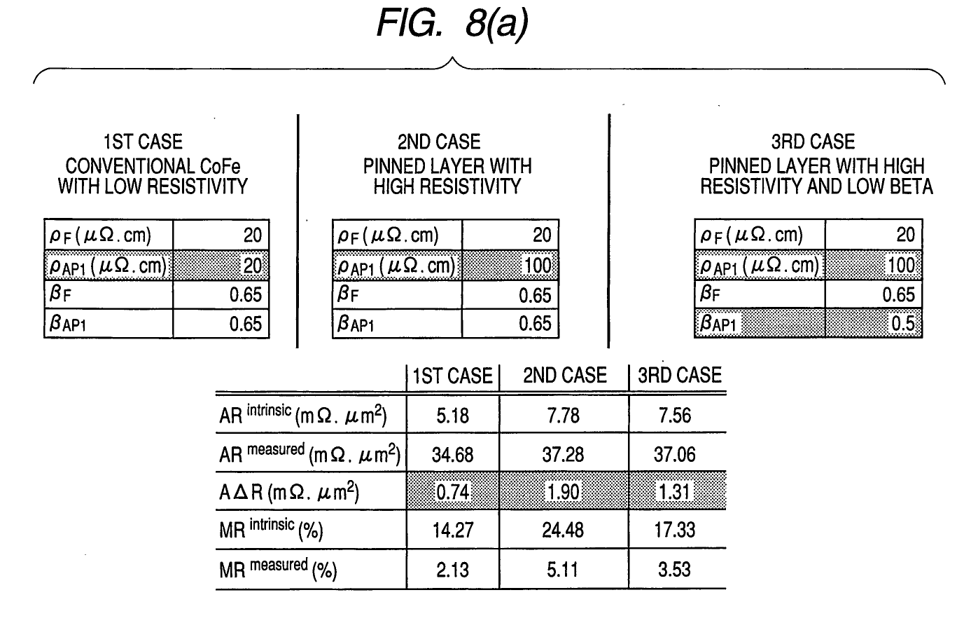

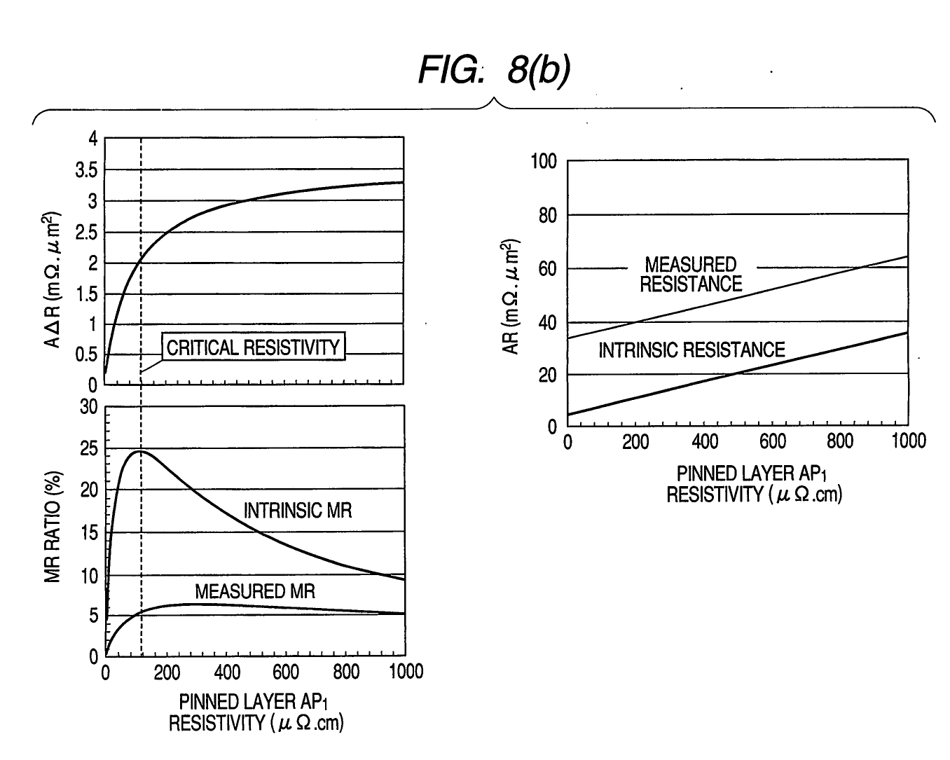

FIG. 8(a) illustrates comparison of simulated performance of various parameters between the related art CoFe pinned layer and the pinned layer 103 according to two exemplary variations of the first exemplary, non-limiting embodiment of the present invention. AP1 in FIGS. 8 to 10 refers to the pinned layer 103 closer to spacer 101. The first variation (second case) uses the pinned layer material optimized to have a high resistivity, and the second variation (third case) uses a pinned layer material optimized to have a high resistivity and a low spin polarization. In this simulation, the calculations take into account all layers of the spin valve except for the shield resistance.

In all cases, the resistance and beta of the free layer 100 remain substantially unchanged. However, resistivity in the pinned layer 103 improves about 5-fold in both variations with respect to the related art pinned layer. Further, in the second variation, the spin polarization is substantially reduced by about 20% in the pinned layer 103.

A comparison of various performance parameters shows that AR and MR are substantially increased in both variations of the present invention as compared with the related art spin valve structure. Further, the value of AΔR is substantially increased between the related art spin valve and both variations of the first embodiment of the present invention. Accordingly, there is a substantial improvement in performance by adding a high resistance material to the pinned layer 103 of the spin valve.

Because the resistance change DR is proportional to spin polarization β, the decreased spin polarization in the second variation (third case) results in a slightly smaller improvement in performance as compared with the first variation (second case).

FIG. 8(b) graphically illustrates the foregoing results. The value of AΔR, the surface area of the free layer 100 multiplied by ΔR, appears to increase at a rapid rate up to a critical resistivity value, and then continues to increase at a more gradual rate. With respect to magnetoresistance, a maximum value of the intrinsic and measured MR is found at the critical resistivity. Because the intrinsic resistivity includes the secondary pinned layer 105 the intrinsic MR has a higher value than the measured MR, which also includes the AFM 107, the buffer layer 108 and capping layer 109.

In this case, the critical resistivity is about 100 μΩcm. Further, for AR, the intrinsic and measured values appear to increase in a substantially linear manner with respect to resistivity.

In the foregoing embodiments, when resistivity is below the critical value, the rate of AΔR increase is higher than that of film resistance.

In order to achieve the foregoing increased resistivity in the production of the pinned and free layer materials described above, a very low pressure of oxygen gas (about 2 percent) mixed with argon is used. This combination affects the resistivity of the metallic film of the pinned layer 103 and optionally the free layer 100.

As noted above, the foregoing high resistivity material may also be used in the free layer 100, either alone or in combination with the pinned layer 103 having the high resistivity material.

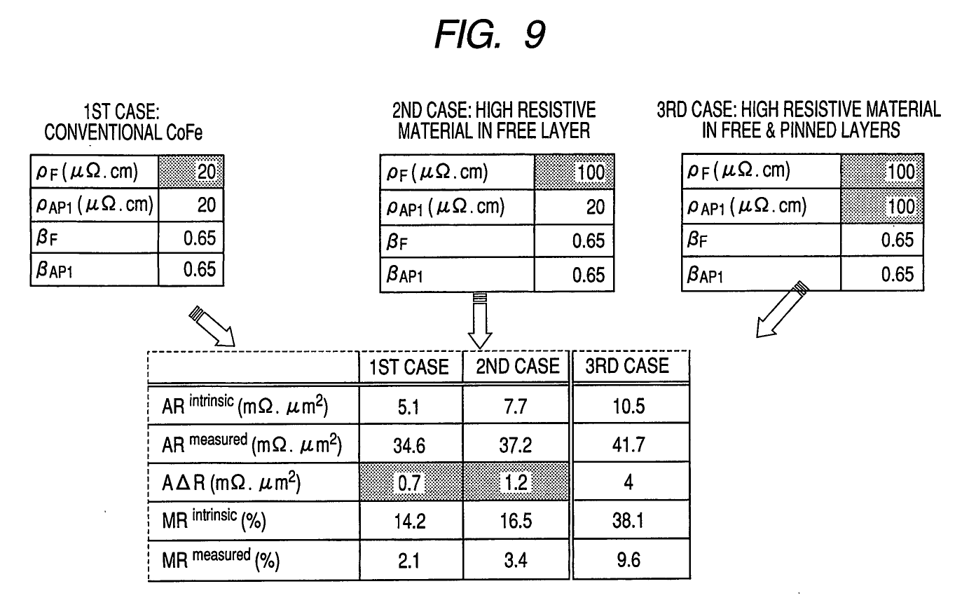

FIG. 9 shows results of a simulation where the high resistivity material is used, in comparison with the related art structure. In the first variation (which is the second embodiment of the present invention), the highly resistive material is used only in the free layer 100, and the in the second variation (which is the third embodiment of the present invention), this material is used in both the free layer 100 and the pinned layer 103.

Similar to the case in FIG. 8(a), the resistivity increases about five-fold when the high resistivity material is used in the respective layers. In comparing the value of MR, AΔR and AR, the first variation with the high resistivity material in the free layer 100 only experiences moderate improvement in all areas with respect to the related art structure. However, in the second variation, a substantially greater increase in all values occurs. For example, but not by way of limitation, the intrinsic AR substantially doubles with respect to the related art structure, and an almost 6-fold increase in AAR is measured. Further, the intrinsic MR increases from 14.2 to 38.1, and the measured MR increases almost 5-fold.

The foregoing results show that performance of the spin valve according to the present invention is substantially improved when the high resistivity material is used in both the free layer 100 and pinned layer 103.

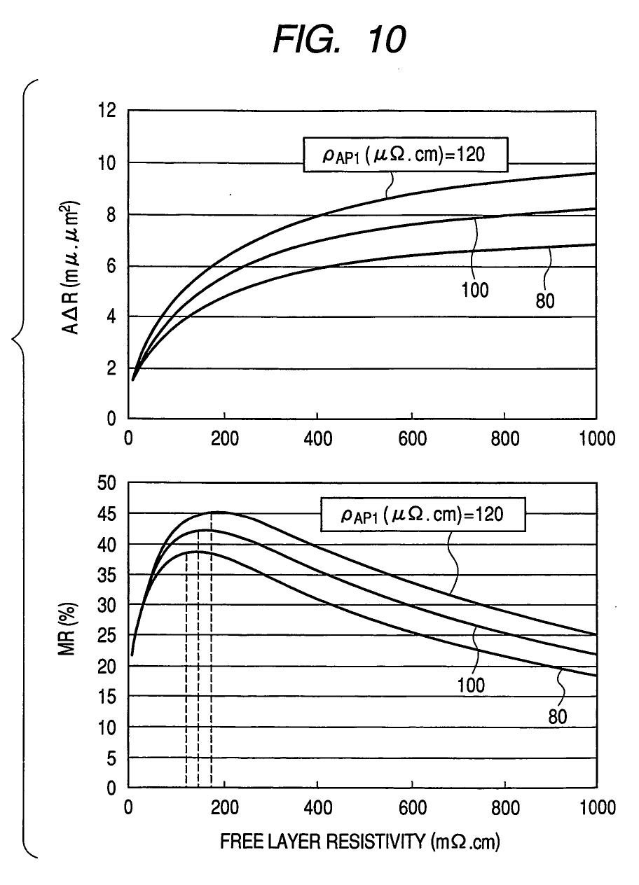

FIG. 10 illustrates performance of an exemplary, non-limiting embodiment of the present invention for a free layer 100 with a high resistivity material and a pinned layer 103 with high resistivity. Three variations in the resistivity of the pinned layer 103 are plotted on a graph of free layer resistivity as compared with AΔR and MR.

As the resistivity of the free layer is increased, the values of AΔR and MR also increase. When the pinned layer resistivity is increased, the values of AΔR and MR are even further increased. Thus, an increase in the resistivity of either or both of the free and/or pinned layers 100, 103 according to the present invention results in improved performance of the spin valve in terms of at least AΔR and MR.

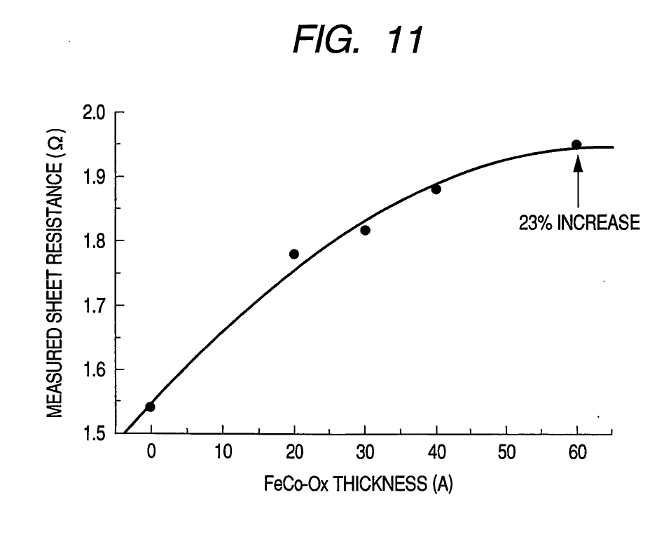

The thickness is also a significant factor in determining resistivity of the ferromagnetic layer. FIG. 11 illustrates the relationship between the thickness of the film that is oxidized by the introduction of the oxygen gas into the deposition process, as a function of sheet resistance. The film thickness is measured in angstroms, and is formed as a thin film on the top of the pinned layer 103 that faces the spacer 101 between the pinned layer 103 and the free layer 100.

As shown in FIG. 11, the resistivity of the sheet increases as the thickness of the oxidized film increases. More specifically, it is also noted that the increase in the sheet resistivity is about 20 percent for a five-fold increase in the resistivity of the rest of the pinned layer. Thus, this relationship between the thickness of the oxidized film on the pinned layer 103 and the overall resistivity of the pinned layer is significant. Similar results would occur for a simulation of the free layer 100.

In a simulation of the formation scheme for the first embodiment, the pinned layer 103 experienced a resistivity about 7 times greater than the reference value of the related art. Further, the magnetic moment is decreased by less than 20%. However, this decrease in magnetic moment can be offset by increasing the thickness of the pinned and/or free layer 103, 100.

Additionally, the sheet resistance experiences a slight increase. For a pinned layer 103 having a thickness of 60 angstroms, resistance increases about 23 percent, which is an unexpected result that has been confirmed by simulation.

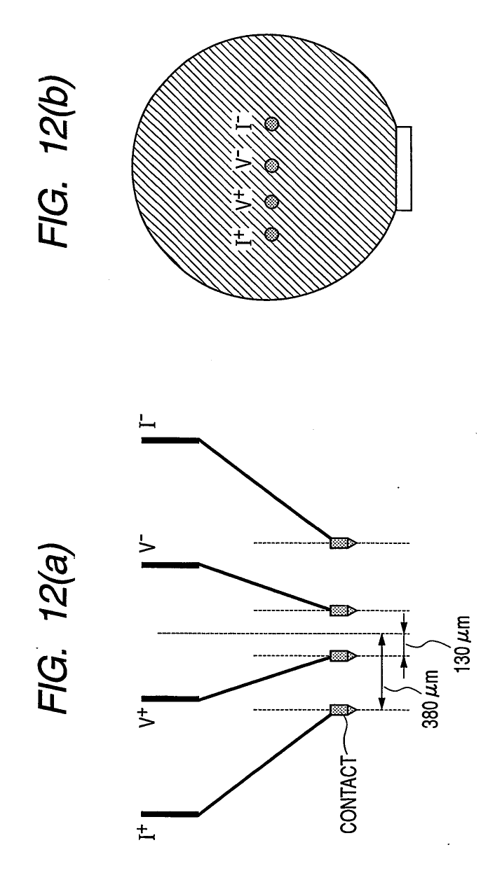

FIGS. 12(a) and (b) show the method of evaluating the resistance of the oxidized film. This measurement can be accomplished both in the presence of an external field and without an applied external field. The method is known as the four points method, and the geometry thereof is described in greater detail below.

FIG. 12(a) shows a side view and FIG. 12(b) shows a top view of the four points of measurement. The current and voltage are measured at adjacent contacts for both positive and negative. The inner contacts are about 260 microns apart from each other, and the outer contacts are about 760 microns apart from each other.

In the foregoing measurement scheme, a constant current is applied to the film and by measuring the voltage resistance can be determined. Resistance versus applied field is then obtained. In these simulations 25 mA current was applied to the film.

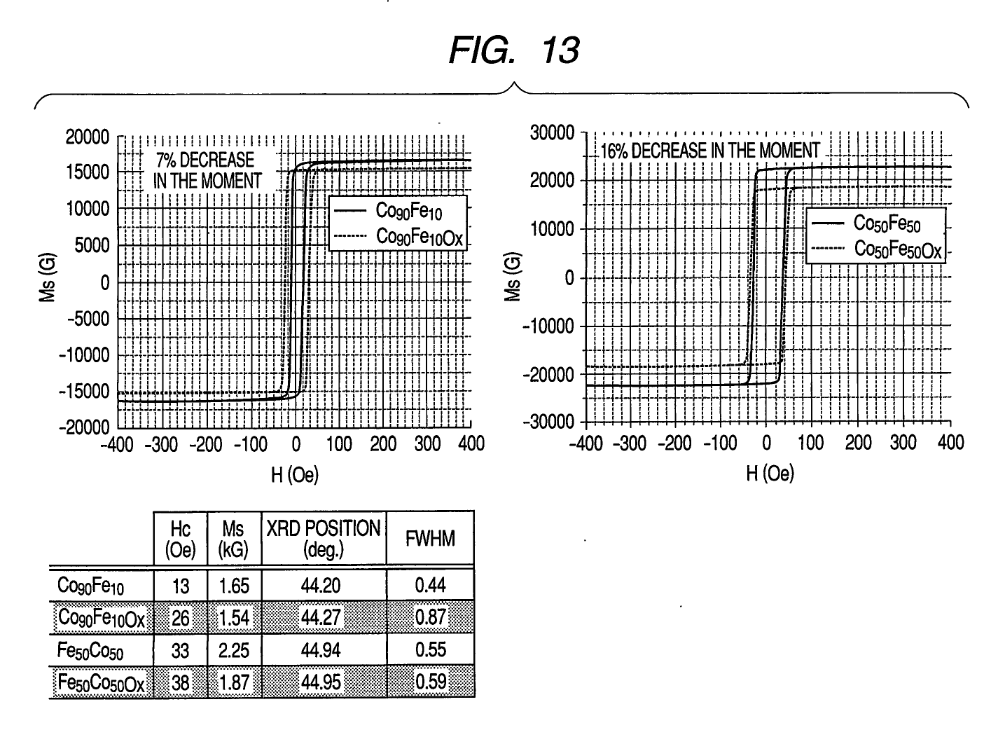

FIG. 13 illustrates the effect of the oxidation according to the exemplary, non-limiting embodiments of the present invention on magnetic properties of the ferromagnetic layer and the thin film. The effects are measured for Co₅₀Fe₅₀ and Co₉₀ Fe₁₀. Magnetization as a function of applied magnetic field is graphed.

For Co₉₀ Fe₁₀, there is a decrease of about 7 percent of its magnetic moment when comparing the oxidized layer with the non-oxidized layer. Further, for Co₅₀Fe₅₀, there is a decrease of about 16 percent in the magnetic moment between the oxidized layer and the non-oxidized layer. However, it is noted that coercivity increases substantially over the same interval in the case of Co₉₀Fe₁₀.

It is believed that these results will apply similarly to the free layer that uses the material of the present invention, as well as the embodiment that employs both the free layer 100 and the pinned layer 103 having that material of the present invention.

For all of the foregoing exemplary, non-limiting embodiments of the present invention, additional variations may also be provided. For example, but not by way of limitation, the pinned layer may either be synthetic or a single layer as described with respect to the related art. Also, the foregoing structure may also be a top or dual type spin valve, as would be understood by one skilled in the art.

Additionally, a stabilizing scheme may be provided, having an insulator and one of an in-stack and hard bias on the sides and/or top of the sensor.

Further, any of the well-known compositions of those layers other than the free layer and pinned layer and their various exemplary, non-limiting exemplary embodiments may be used, including (but not limited to) those discussed above with respect to the related art. For example, but not by way of limitation, a synthetic pinned layer or a single-layered pinned layer may be used. Because the compositions of those other layers is well-known to those skilled in the art, it is not repeated here in the detailed description of this invention, for the sake of brevity.

The present invention has various advantages. For example, but not by way of limitation, a relatively high resistance in the magnetoresistive head element is achieved. As a result, the performance of the spin valve is substantially improved as measured by at least MR, AR and AΔR. When the foregoing structure is applied to the pinned layer as well, the strength of the pinning field is substantially improved.

The present invention is not limited to the specific above-described embodiments. It is contemplated that numerous modifications may be made to the present invention without departing from the spirit and scope of the invention as defined in the following claims.

### INDUSTRIAL APPLICABILITY

The present invention has various industrial applications. For example, it may be used in data storage devices having a magnetic recording medium, such as hard disk drives of computing devices, magnetic random access memory, multimedia systems, portable communication devices, and the related peripherals. However, the present invention is not limited to these uses, and any other use as may be contemplated by one skilled in the art may also be used.

1. A magnetic sensor for reading a recording medium and having a spin valve, comprising:
a free layer having a magnetization adjustable in response to an external field;
a pinned layer having a fixed magnetization and including a high resistivity material in at least a portion of said pinned layer, said pinned layer having a resistivity between about 80 μΩcm and about 150 μΩcm; and
a spacer sandwiched between said pinned layer and said free layer.

2. The magnetic sensor of claim 1, further comprising:
an antiferromagnetic (AFM) layer positioned on a surface of said pinned layer opposite said spacer, that stabilizes said fixed magnetization;
a capping layer sandwiched between said free layer and a top lead; and
a buffer sandwiched between said AFM layer and a bottom lead, wherein a sensing current flows between said top lead and said bottom lead.

3. The magnetic sensor of claim 1, wherein said resistivity of said pinned layer is one of about 90 μΩcm and about 100 μΩcm.

4. The magnetic sensor of claim 1, wherein at least a portion of said free layer includes said high resistivity material and has a resistivity between about 20 μΩcm and about 200 μΩcm.

5. The method of claim 4, wherein said at least a portion of said free layer comprises one of a sublayer in said free layer and all of said free layer.

6. The magnetic sensor of claim 1, wherein at least a portion of said free layer includes said high resistivity material and has a resistivity of about 100 μΩcm and said resistivity of said pinned layer is about 100 μΩcm.

7. The method of claim 6, wherein said at least a portion of said free layer comprises one of a sublayer in said free layer and all of said free layer.

8. The magnetic sensor of claim 1, wherein said high resistivity material comprises Co₁₀₀₋ₓFeₓ, wherein X has a value that is one 10, 16, 25, 35, 50, 65, 75 and 100, and said value is accurate within a range of plus or minus 20%.

9. The method of claim 1, wherein said at least a portion of said pinned layer comprises one of a sublayer in said pinned layer and all of said pinned layer.

10. The magnetic sensor of claim 1, further comprising a stabilizer having at least one of (a) a hard material at a side of the magnetic sensor and (b) an in-stack bias on a top of the magnetic sensor.

11. The magnetic sensor of claim 1, further comprising a side shield.

12. The magnetic sensor of claim 1, wherein said pinned layer is one of synthetic and a single layer, and said spin valve is one of a top type, a bottom type, and a dual type, and said pinned layer is one of (a) single-layered and (b) multi-layered with a spacer between sublayers thereof.

13. The magnetic sensor of claim 1, wherein said high resistivity material comprises said pinned layer deposited in an argon gas environment having at least 2 percent oxygen gas

14. A magnetic sensor for reading a recording medium and having a spin valve, comprising:
a free layer having a magnetization adjustable in response to an external field and including a high resistivity material in at least a portion of said free layer, said free layer having a resistivity between about 20 μΩcm and about 200 μΩcm;
a pinned layer having a fixed magnetization; and
a spacer sandwiched between said pinned layer and said free layer.

15. The magnetic sensor of claim 14, further comprising:
an antiferromagnetic (AFM) layer positioned on a surface of said pinned layer opposite said spacer, that fixes said pinned layer magnetization;
a capping layer sandwiched between said free layer and a top lead; and
a buffer sandwiched between said AFM layer and a bottom lead, wherein a sensing current flows between said top lead and said bottom lead.

16. The magnetic sensor of claim 14, wherein said resistivity of said free layer is about 100 μΩcm.

17. The magnetic sensor of claim 14, wherein said high resistivity material comprises Co₁₀₀₋ₓFeₓ, wherein X has a value that is one 10, 16, 25, 35, 50, 65, 75 and 100, and said value is accurate within a range of plus or minus 20%.

18. The magnetic sensor of claim 14, further comprising a stabilizer made of at least one of (a) a hard material at a side of the magnetic sensor and (b) an in-stack bias on a top of the magnetic sensor.

19. The magnetic sensor of claim 14, wherein said spin valve is one of a top type, a bottom type, and a dual type, and said pinned layer is one of (a) single-layered and (b) multi-layered with a spacer between sublayers thereof.

20. The magnetic sensor of claim 14, wherein said high resistivity material comprises said pinned layer deposited in an argon gas environment having at least 2 percent oxygen gas

21. A magnetic sensor for reading a recording medium and having a spin valve, comprising:
a free layer having a magnetization direction adjustable in response to an external field;
a pinned layer having a fixed magnetization; and
a spacer sandwiched between said pinned layer and said free layer,
wherein a high resistivity material is positioned in a portion of at least one of (a) said pinned layer having a resistivity greater than about 80 μΩcm, and (b) said free layer having a resistivity greater than about 20 μΩcm, and
wherein said high resistivity material is formed by performing deposition of said at least one of said pinned layer and said free layer in an argon gas environment having at least 2 percent oxygen gas.
